(19) United States
(12) Patent Application Publication
(10) Pub. No.: US 2012/0179966 A1
(43) Pub. Date: Jul. 12, 2012

(54) SYSTEMS AND METHODS FOR PRODUCING HYBRID ELECTRONIC DATA FORMS INCLUDING LINKED MULTIMEDIA FILES

(76) Inventor: Paul Kappos, Centerville, UT (US)

(21) Appl. No.: 13/346,594

(22) Filed: Jan. 9, 2012

Related U.S. Application Data
(60) Provisional application No. 61/430,844, filed on Jan. 7, 2011.

(51) Int. Cl. G06F 3/00

(52) U.S. Cl. 715/716

(57) ABSTRACT

An exemplary system includes a GUI accessed system that can be accessed to generate and produce hybrid electronic data forms that link line items generated on an estimate, bill, or work report to any number of multi-media files.

### RELATED APPLICATIONS

This application claims priority of U.S. Provisional Patent Application No. 61/430,844 titled “Systems and Methods for Producing Hybrid Electronic Data Forms Including Linked Multimedia Files” filed on Jan. 7, 2011, which application is incorporated herein by reference in its entirety.

### BACKGROUND

The popularity of the Internet has made papered documents and record keeping essentially obsolete. In fact, a large portion of the population uses the internet for obtaining news, communicating with friends and family via chat rooms and instant messaging, and for work.

Similarly, digital personal music, communication, and computing devices have become mainstream. Recently, cell phones have been configured to include multiple functions including, word processing, video capture and editing, and gaming

Due to the ubiquitous dissemination of smart cell phones and tablet based computers, a need exists for a more robust digital record keeping system.

### SUMMARY

According to at least one embodiment, a computer-implemented method to associate multimedia files to a line item in a form is described. Multimedia files are collected and associated with singular line items on a word document or form. The association of the multimedia files is maintained by a file association module, which, when accessed by a processor, is able to provide the associated media files as needed.

In one configuration, a computer-implemented method to associate multimedia files with a document line item, includes generating a graphical user interface configured to receive the entry of line item information, accessing one or more multimedia recording functionalities of the computing device, collecting a multimedia file, and associating the multimedia file with a line item entered into the graphical user interface.

In another configuration, the computer-implemented method includes transmitting the multimedia file to a remote computing device.

In yet another configuration, a computing system configured to associate multimedia files with a document line item includes a processor, memory in electronic communication with the processor, a file association application stored in the memory, the application including an audio recording module programmed to collect audio recordings and associate the audio recordings to a line item in a document, a video recording module programmed to collect video recordings and associate the video recordings to a line item in a document, an image recording module programmed to collect images and associate the images to a line item in a document, a document recording module programmed to collect documents and associate the documents to a line item in a document, and a display configured to graphically display the association of the audio recordings, the video recordings, the image recordings, and the documents to the line item.

In yet another embodiment, a computer-program product for associating multimedia files with a document line item, the computer-program product including a non-transitory computer-readable medium having instructions thereon, the instructions including, code programmed to generate a graphical user interface configured to receive the entry of line item information, code programmed to access one or more multimedia recording functionalities of the computing device, code programmed to collect a multimedia file, and code programmed to associate said multimedia file with a line item entered into said graphical user interface.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate various embodiments of the principles described herein and are a part of the specification. The illustrated embodiments are merely examples and do not limit the scope of the disclosure. Throughout the drawings, identical reference numbers designate identical or similar elements.

FIG. 1 is a screen shot of a graphical user interface (GUI), according to principles described herein.

FIG. 2 is a screen shot of a GUI illustrating the video capture of an event associated with a line item, according to principles described herein.

FIG. 3 is a screen shot of a GUI illustrating the video playback of an event associated with a line item, according to principles described herein.

FIG. 4 is a screen shot of a GUI illustrating the image capture of an event associated with a line item, according to principles described herein.

FIG. 5 is a screen shot of a GUI illustrating the image display of an event associated with a line item, according to principles described herein.

FIG. 6 is a screen shot of a GUI illustrating the audio capture of an event associated with a line item, according to principles described herein.

FIG. 7 is a screen shot of a GUI illustrating the audio playback of an event associated with a line item, according to principles described herein.

FIG. 8 is a screen shot of a GUI illustrating the capability of displaying all of the line-item media associated with a single form, according to principles described herein.

FIG. 9 is a screen shot of a GUI illustrating the capability of displaying all of the media associated with a single line-item, according to principles described herein.

FIG. 10 is a block diagram illustrating one embodiment of an environment in which the present systems and methods may be implemented.

FIG. 11a illustrates various components that may be used in a mobile communications device.

FIG. 11B is a block diagram illustrating one embodiment of a file association module.

FIG. 12 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

This specification describes systems and methods for generating an electronic data form configured to link line-item data to any number of captured multi-media files. The systems and methods described herein facilitate the capture of line item information, the capture of associated multi-media files, and the association of the two. Additionally, the present exemplary system provides for facilitating the generation of both electronic and hard-copy forms, reports and displays associated with the line-items. Furthermore the present exemplary system provides for the execution of a billing process based on the agreed upon line item forms. One exemplary billing process may include financial tracking and payment tracking.

Compared with conventional line item systems, the systems and methods described herein are easier to implement, better for establishing a solid record, and generally more productive for any entity committed to incorporating the system. Significantly, the systems and methods described herein facilitate both data collection and report generation.

These and other uses and benefits of the systems and methods described herein will become apparent upon consideration of the following examples.

### II. Exemplary System View

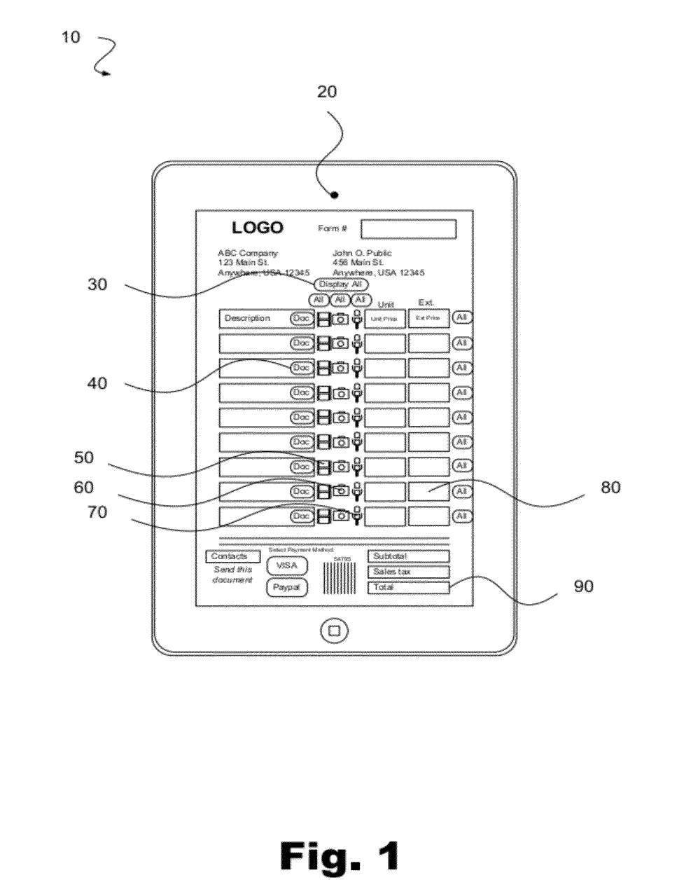

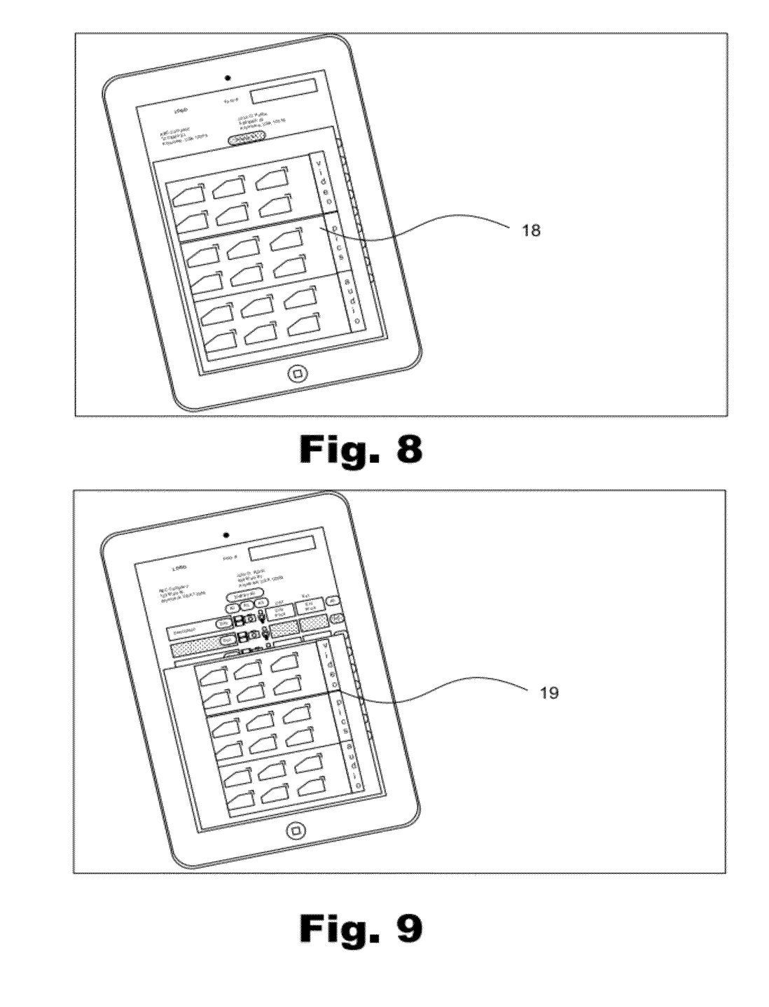

FIGS. 1-9 illustrate various views of a graphical user interface (GUI) for implementing the present exemplary system and method.

As illustrated in FIG. 1, the exemplary system 10 includes a tablet or other computing device having a camera 20 for line item media capture. As illustrated, the tablet or other computing device includes a graphical user interface (GUI) having a line item interactive display. As shown, the interactive display includes interactive buttons 30 for accessing and indicating when a line item media is available. Furthermore, a number of line item fields 80 are generated for the entry of information in line-item form. Each line item field 80 includes a number of integrated line item buttons for accessing associated documents 40, videos 50, pictures 60, audio clips 70, or any other desired multimedia files associated with the line item field. Additionally, the GUI includes fields for the real time payment/disbursement of payment to multiple entities, as well as real time updates to third party financial tracking services 90. Further details of the GUI interface and its associated features will be provided below.

Specifically, the present exemplary system and method is a GUI accessed system that can be accessed to generate and produce hybrid electronic data forms that link line items generated on an estimate, bill, or work report to any number of multi-media files. Specifically, the system may, according to one embodiment, include the following features:

According to one exemplary embodiment, the present exemplary system provides a word-processing type of an interface that includes a number of lines for generating line items 80 as well as an icon 40, 50, 60, 70 for each line item. The interface may also be configured to receive a scanned document, perform an optical character recognition (OCR) or other similar document recognition/generation operation to recreate and allow for the modification of the scanned document (in grayscale overlay) to create a new personalized and repeatable document.

According to one exemplary embodiment, the icon 40, 50, 60, 70 associated with each line item 80, when initially selected initiates a program that completes a handshake protocol and provides a list of available multimedia options and devices to the user.

When a multimedia device/option is selected by the user, that device/option is activated and a multimedia file may be created. (Multimedia files may include, but are in no way limited to, photos, videos, graphic files, pictures, audio, url, gifs, tiffs, pdfs, barcodes, and the like.) Additionally, according to one exemplary embodiment, links to streaming video may be associated with various line items.

When a multimedia file is created, it is stored with a pointer or other designator that associates the multimedia file with the line item created on the document. Accordingly, when the line item is selected, the pointer or other designator associates that multimedia file with the selected line item for retrieval, display, or other presentation to the user. Selection of the line item may be accomplished with a traditional mouse pointer or using touch input and selection, such as via a touch screen.

According to one exemplary embodiment, the application creating the GUI is also in control of the display device, the storage device, and the multimedia collection device. Accordingly, the application creating the GUI is configured to communicate with and provide instructions to the display device, the storage device, and the multimedia collection device.

Additionally, when the multimedia file is created, the icon 40, 50, 60, 70 associated with that line 80 item is changed such that when subsequently selected, the multimedia file is available for display, access and presentation.

According to one exemplary embodiment the icon 40, 50, 60, 70 is visually modified to illustrate the type of multimedia file and its content that is associated with the line item such that a user, when viewing the line item document as a whole, is able to readily identify the types of multimedia files that are associated with each line item on the report. This functionality allows for the user to know what options are available, and also allows the user the ability to quickly identify where there may be deficiencies in maintaining an appropriate A/V record and the deficient areas may be supplemented.

The multimedia item associated with each line item may perform any number of functions and benefits to the user. For example, according to one exemplary embodiment, the multimedia item associated with a line item may be proof of work, sign-off by client that work was satisfactorily performed, proof of change-orders and authorization to proceed, delivery of materials, identification of potential defects, list of items to be completed, instructional information related to an illness, wound care, or procedure to be performed (in the field of medicine), instructions for a student on how to perform an assignment, military orders and/or mission details, etc.

All of the information (including employee hours, performance, cost, and profit, as well as the associated multimedia) is fed into a central server for the company (either local or housed in a remote location). The information housed on the central server is accessed by a software system that analyzes the information received and calculates a number of metrics that are useful to the company. Specifically, performance and efficiency metrics can be calculated and compared to internal benchmarks, community benchmarks, national benchmarks, and any other regional or temporal benchmarks that are available. According to this exemplary embodiment, any number of filters and/or parameters may be selected to define and narrowly tailor the scope of the comparison being performed. Additionally, the received information can be used to generate time cards, bill payment, etc.

The information provided to the central server and then analyzed by the associated software may be fed into a home office server either in real-time via a wireless or hardwire connection, or may be saved and prepared for transmission upon docking or next time system is connected to a wireless or hardwired service.

Furthermore, the information sent to a central server may be housed by a safeguarding company that maintains records for a company for safekeeping or backup. According to this exemplary system, the records may be maintained in the central server to act as an escrow agent or document retention agent, able to provide requested documents to customers in the event of a disputed line item form, a lawsuit, a claim, etc.

Furthermore, according to one exemplary embodiment, the present exemplary system may be used to generate, prepare, and file mechanic's liens with a state or federal agency. Specifically, according to one exemplary embodiment, the system may use line items to request needed information from the user that can then be used to automatically file a mechanics lien on any property the user is working on. This automated feature assures that a proper lien is in place while documenting start and end dates, using multimedia.

Furthermore, according to one exemplary embodiment, the present exemplary system and method may be used to generate performance reports including links to multimedia. Such reports may be used to create employee review documents, report cards for students, etc.

Furthermore, according to one exemplary embodiment, the present exemplary system and method may be used to generate a receipt for items purchased. This electronic receipt may include line items for each purchased item. Additionally, a mini-commercial, directed advertisement, or link to a website may be associated with each line item entered for purchased items.

The exemplary application can be housed and processed on any computing device including, but in no way limited to, an iPhone, an iTouch, an iPad, an iPod, a PC, a laptop, a smart phone, a smart camera, a smart or network enabled video camera, and the like.

According to one exemplary embodiment, the present exemplary system and method is a line item management system wherein each data entry, multimedia file, etc. is linked to a line item on the electronic form being generated. According to one exemplary embodiment, the line items and the associated files are linked together in a file tree format with the form number being the highest identifying link, followed by sub-categories of headings, line items, charge information, and the like. Each of the sub-categories may include a sub-sub-category linking a data file and/or a multimedia file to the specific line item.

Furthermore, according to one exemplary embodiment, the receipt of a multimedia file by the present system may be performed via a data link. Specifically, the collection of the multimedia file need not be directly from a handheld device or other item associated with the system. Rather, the transmission of multimedia may be accomplished via software (i.e. a data link) associated with a separate device or software. According to this exemplary embodiment, the user may receive, via their handheld device or other communication device, a file. That file may then be incorporated into the GUI of the present system and dropped into or otherwise associated with a specific line item.

According to one exemplary embodiment, the present exemplary system may be communicatively coupled to the central database and/or other applications by a data communication network. In some examples, the data communication network includes the Internet or World Wide Web. Access devices, may communicate over data communication network using any known communication technologies, devices, media, and protocols supportive of remote communications, including, but not limited to, transmission media, communications devices, Transmission Control Protocol (“TCP”), Internet Protocol (“IP”), File Transfer Protocol (“FTP”), telnet, Hypertext Transfer Protocol (“HTTP”), socket connections, packet-switching technologies, circuit-switching technologies, wireless communication technologies (e.g., cellular telephone and wireless access technologies), and any other suitable communications technologies.

Specifically, according to one exemplary embodiment, the data communication network used for the communication between devices and the central database may include, but is in no way limited to, one or more networks suitable for carrying communications between access devices. For example, data communication network may include, but is not limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between access devices.

Each access device incorporating the present exemplary systems and methods may include any device or devices physically or remotely accessible to one or more consumers and that allows a consumer to provide input to and/or receive output from the user and/or a central database over a data communication network. For example, the access device can include, but is not limited to, one or more desktop computers, laptop computers, tablet computers, personal computers, personal data/digital assistants, cellular telephones, iPhones, iTouches, iPads, satellite pagers, wireless internet devices, embedded computers, video phones, network interface cards, modems, optical network terminals, mainframe computers, mini-computers, programmable logic devices, vehicles, entertainment devices, gaming devices, music devices, wireless communication devices, wireline communication devices, Internet Protocol (“IP”) devices (e.g., IP-based phones), Session Initiation Protocol (“SIP”) devices (e.g., SIP phones), set-top boxes, televisions, display devices, and any other devices capable of communicating with other devices or databases. The access device can also include various peripherals such as a terminal, keyboard, keypad, trac or touch pad, mouse, screen, printer, stylus, microphone, audio speaker, input device, output device, or any other apparatus that can help a user interact with access device.

The access device may include instructions for generating and operating user interfaces and for displaying and adding functionality to the presently described graphical user interface. These instructions may be in any computer-readable format, including software, firmware, microcode, and the like. When executed by a processor (not shown) of a particular access device, the instructions may present one or more user interfaces to a user. The user interfaces may be configured to present information to and receive input from consumers, including information associated with jobs, line items, multimedia, purchase processing, and the like. The user interfaces may comprise one or more graphical user interfaces (“GUI”) capable of displaying information in line item form, saving multimedia files and receiving input from users. In certain embodiments, the user interfaces include one or more web browsers, such as Internet Explorer® offered by Microsoft Corporation of Redmond, Wash.

The present exemplary system may also incorporate a data store that may include one or more data storage mediums, devices, or configurations and may employ any type, form, and combination of storage media known to those skilled in the art, including hard disk drives, read-only memory, caches, databases, optical media, and random access memory. The data store may include any known technologies useful for storing, updating, modifying, accessing, retrieving, and deleting data. According to one exemplary embodiment, the multimedia file or data file that is linked to a specific line item on the present exemplary GUI may be resident on a data store physically present on the computing device, or alternatively, the multimedia file or data file may be accessed via cloud computing via a service provider, or other access to a server or server farm.

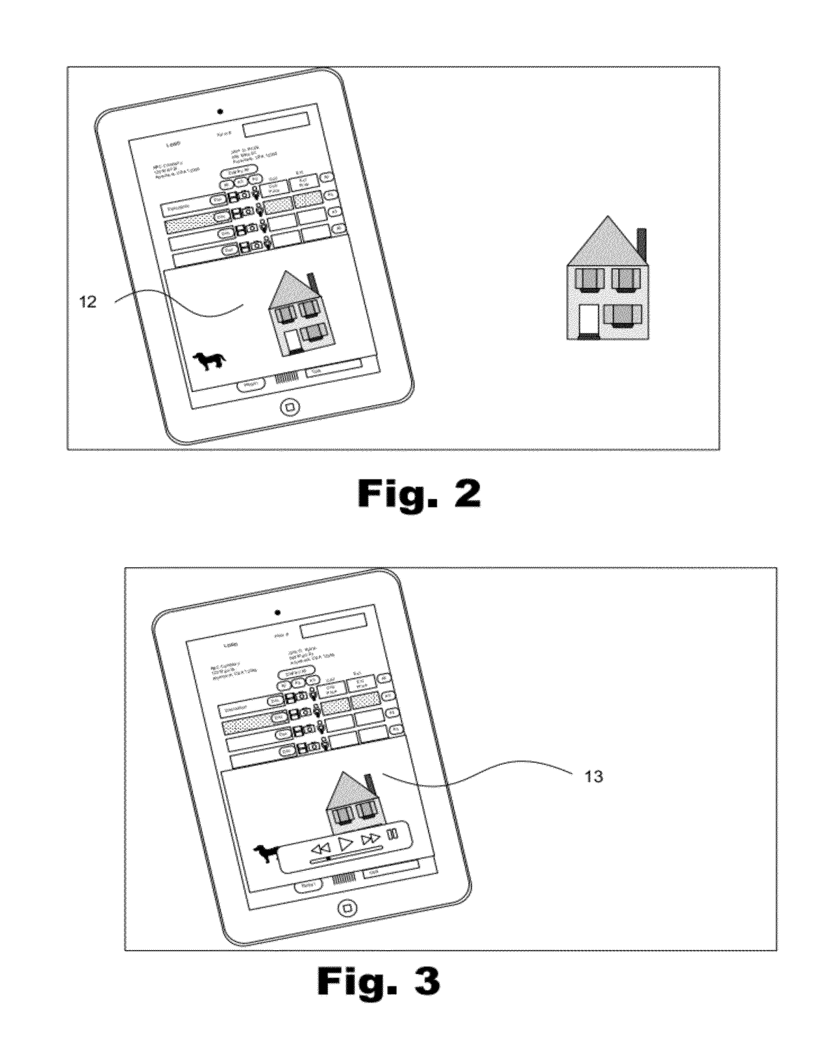

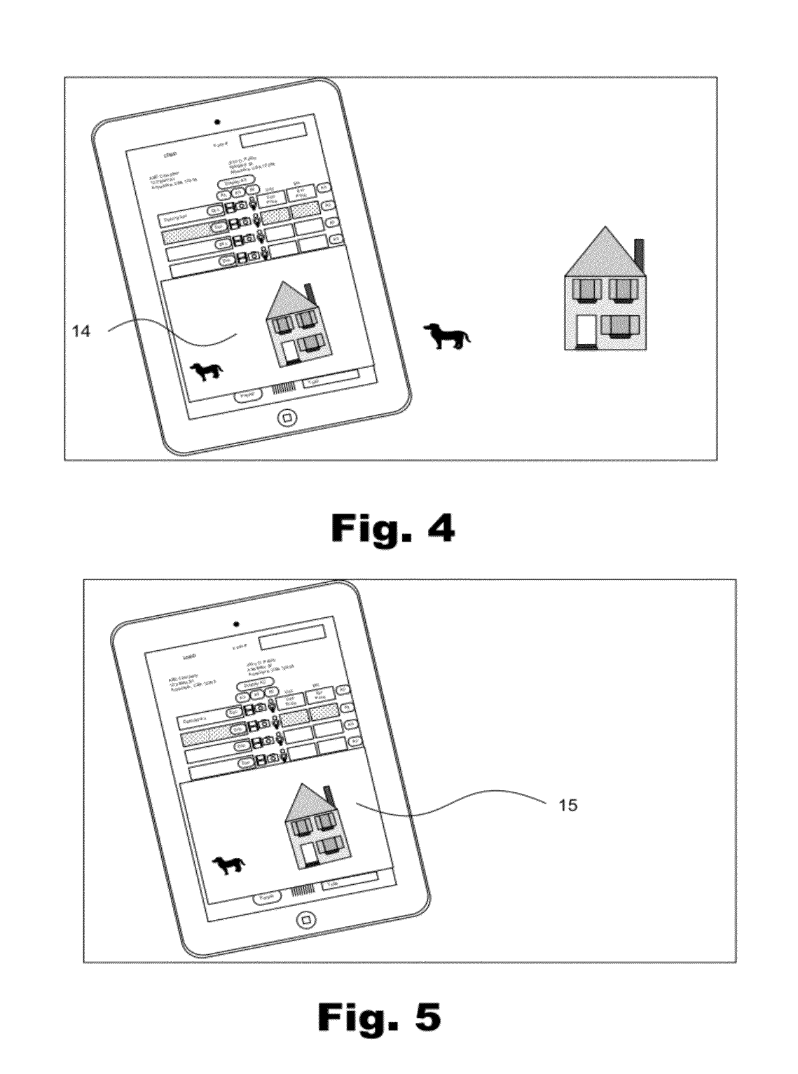

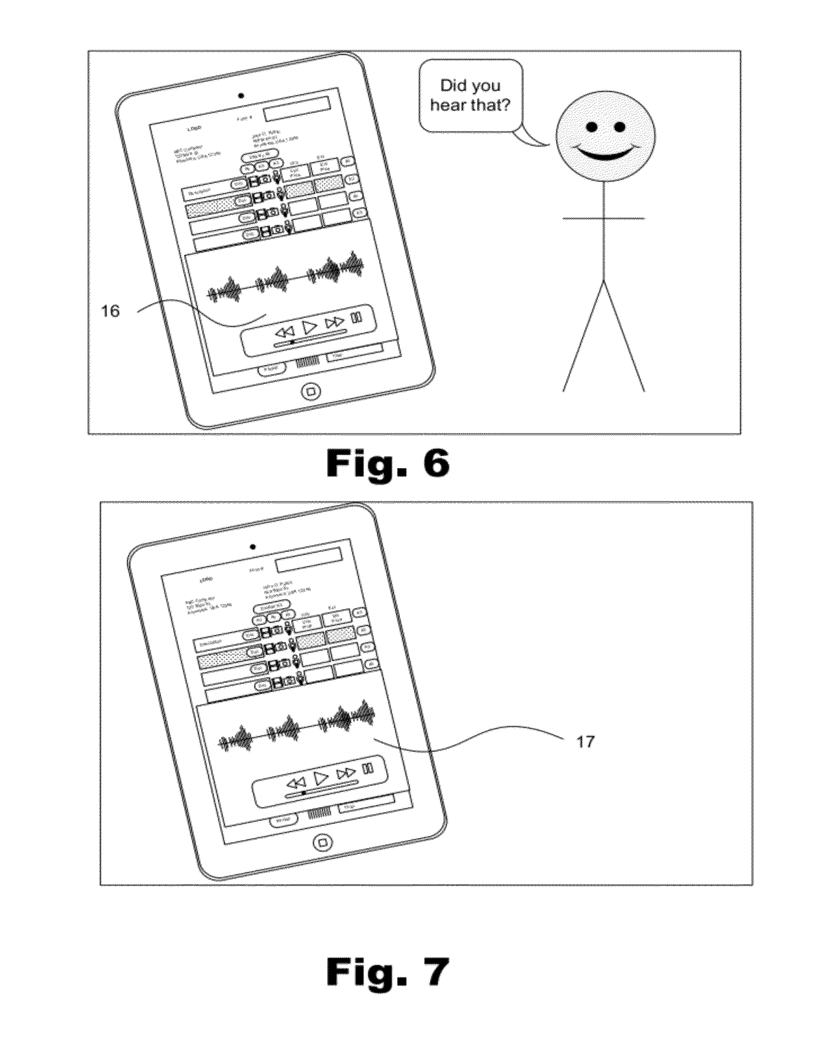

As illustrated in the Figures, the multimedia files, when accessed, are displayed over the actual line item form that they are associated with. For example, as illustrated in FIGS. 2 and 3, a video 12 may be captured and associated with a line item (highlighted). When later accessed, the played video 13 will again be associated with the line item. Similarly, as illustrated in FIGS. 4 and 5, a still image 14 may be captured and associated with a line item (highlighted). When later accessed, the still image 15 will again be associated with the line item. Furthermore, as illustrated in FIGS. 6 and 7, an audio recording 16 may be captured and associated with a line item (highlighted). When later accessed, the audio recording 17 will again be associated with the line item.

When multiple multimedia or data files associated with a line item are accessed 19, they are each scaled over the form such that portions of the form can still be seen, including the selected line item. According to one exemplary embodiment, the line item associated with the selected multimedia or data files is highlighted on the form such that intellectual and visual orientation is provided to the user. In other words, the user is always visually aware of what is being viewed and how the viewed files are associated with the underlying line item form.

Similarly, with portions of the underlying form being visible during the view of the associated multimedia and data files, all data files may be viewed 18 and then the various files may be independently selected, copied, cut and/or dragged to similarly be associated with other line items. According to this exemplary embodiment, when a data or multimedia file is moved to be associated with another line item, the pointer and/or the data tree structure of the data may be modified to reflect the modification.

Additionally, according to one exemplary embodiment, the present system and method provide the user with an ability to pre-associate a media capture or data capture with a specific line item on a form being created. According to this exemplary embodiment, the form may be accessed and the line item selected. Subsequent to the selection of the line item to be associated with the multimedia capture, a capture device is activated and communicated to by the present system (either resident in the user's computing device, or separate). In communicating with the capture device, the present exemplary system provides instructions to the device of where to transmit and how to associate the captured media with a line item. The connection between the user's computing device and the capture device may be hard wired, wireless, Bluetooth, or any other data communication protocol.

Additionally, according to one exemplary embodiment illustrated in the Figures, the present exemplary system and method also allow the user's computing device to facilitate the real time payment and disbursement of funds for one or more entities and for one or more line items using traditional credit card, bank transfer, paypal, or other online and/or traditional payment systems. Accordingly, the present exemplary system the data associated with the transactions may also be incorporated and communicated to any number of ranking and /or customer service evaluation websites for a grade and or instant feedback.

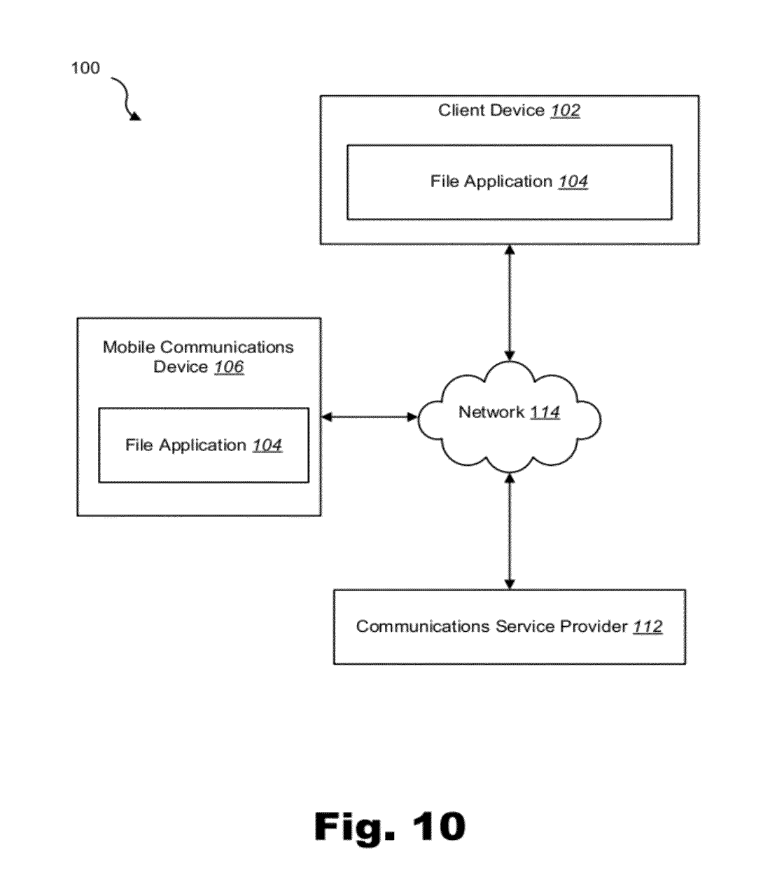

FIG. 10 is a block diagram illustrating one embodiment of an environment 100 in which the present systems and methods may be implemented. In one example, a client device 102 may communicate with a number of other devices, systems, and providers. For example, the client device 102 may communicate with a mobile communications device 106 and a communications service provider 112. The communications may be across a network 114 connection. In one configuration, the client device 102 may be a smartphone, a cellular phone, a personal computer (PC), a laptop, a tablet, a personal digital assistant (PDA), or any other type of computing device. The mobile communications device 106 may include, but is not limited to, a cellular phone, a smartphone, a cellular enabled computing device, or any other type of communications device.

In one embodiment, the client device 102 may include a file association application 104. The file association application 104 may provide an interface to a user of the client device 102. In one example, the file association application 104 may provide aggregated data to the user relating to a number of different audio visual files with a line item in a form. The file association application 104 may provide information relating to the association and file available via text or graphical icon. This information may be communicated to the file association application 104 from the mobile communications device 106 across the network 114.

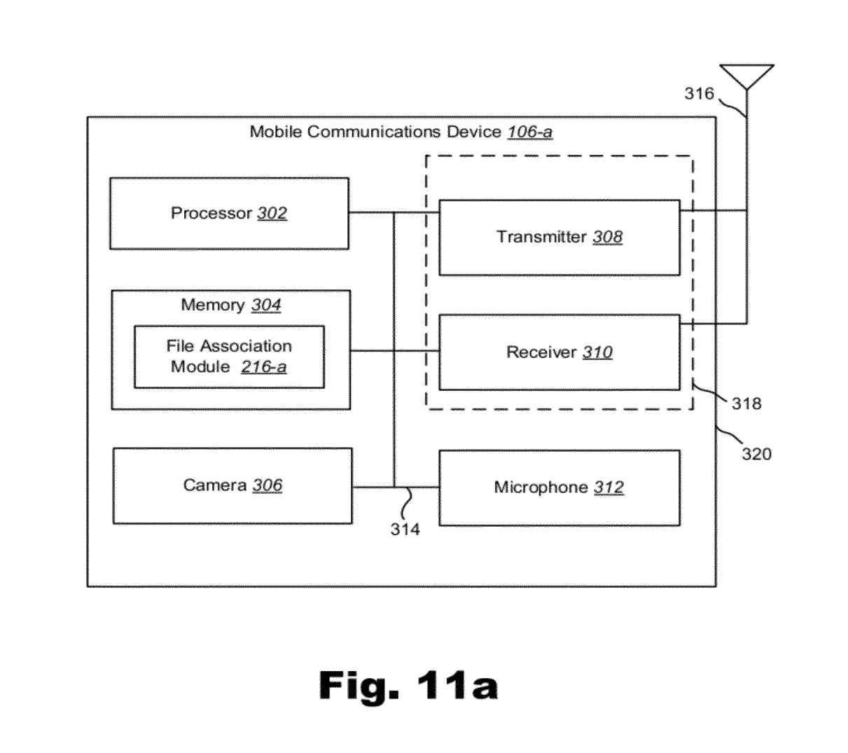

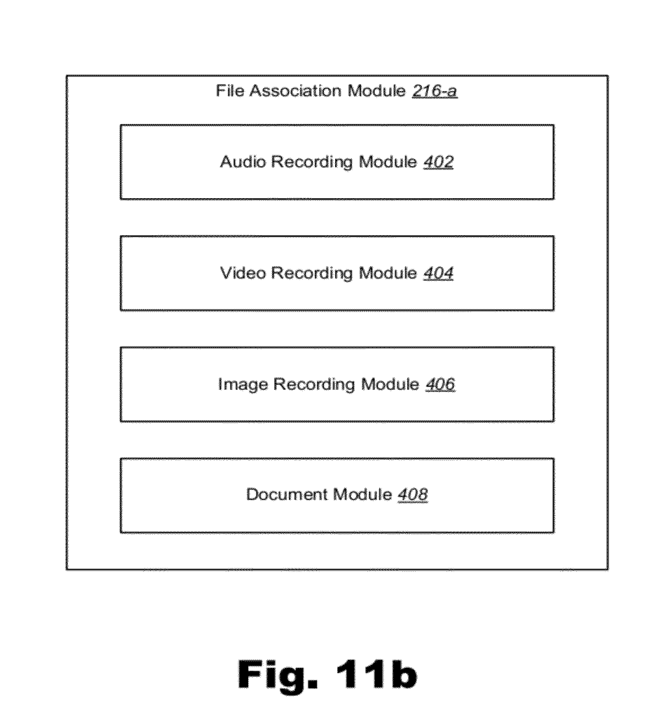

FIG. 11a illustrates various components that may be used in a mobile communications device 106-a. The communications device 106-a is an example of the mobile computing device 10 of FIG. 1 that has mobile communications enabled.

The communications device 106-a may include a processor 302 which controls operation of the communications device 106-a. The processor 302 may also be referred to as a central processing unit (CPU). Memory 304, which may include both read-only memory (ROM) and random access memory (RAM), provides instructions and data to the processor 302. A portion of the memory 304 may also include non-volatile random access memory (NVRAM). The processor 302 typically performs logical and arithmetic operations based on program instructions stored within the memory 304. The instructions in the memory 304 may be executable to implement the methods described herein. For example, a file association module 216-a may be stored in the memory 304. The file association module 216-a may be an example of the file application 104 stored in the devices of FIG. 10. As a result, the file association module 216-a may determine the association between received audio visual files and line items.

The communications device 106-a may also include a housing 320 that may include a transmitter 308 and a receiver 310 to allow transmission and reception of data between the communications device 106-a and a remote location. The transmitter 308 and receiver 310 may be combined into a transceiver 318. An antenna 316 may be attached to the housing 320 and electrically coupled to the transceiver 318. The communications device 106-a may also include (not shown) multiple transmitters, multiple receivers, multiple transceivers and/or multiple antennas.

The communications device 106-a may also include a camera 306 that may be used to capture still and video images to be associated with a line item. The communications device 106-a may also include a microphone 312 for use in capturing audio data to be associated with a line item.

The various components of the communications device 106-a may be coupled together by a bus system 314 which may include a power bus, a control signal bus, and a status signal bus in addition to a data bus. However, for the sake of clarity, the various busses are illustrated in FIG. 3 as the bus system 314.

FIG. 11b is a block diagram illustrating one embodiment of a file association module 216-a. The file association module 216-a may be an example of the file application of FIG. 10. In one configuration, the module 216-a may include an audio recording module 402, a video recording module 404, an image recording module 406, and a document module 408.

In one example, the audio recording module 402 may monitor the audio I/O receive by the microphone to determine whether the audio is to be recorded. When a signal indicative of a need to record is received, the audio recording module records the received audio and associates the file with a specified line item. Similarly, the video recording module 404, the image recording module 406, and the document module 408 each record their respective information and associate the resulting files with specified line items, to be accessed when selected by a user in the line item form.

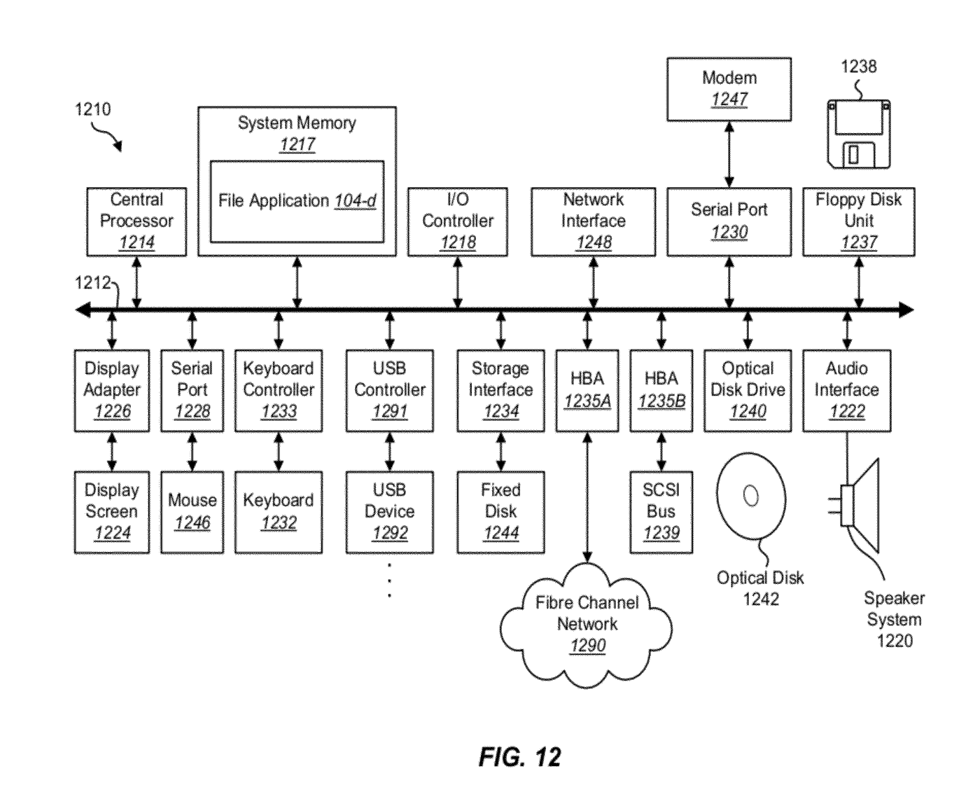

FIG. 12 depicts a block diagram of a computer system 1210 suitable for implementing the present systems and methods. Computer system 1210 includes a bus 1212 which interconnects major subsystems of computer system 1210, such as a central processor 1214, a system memory 1217 (typically RAM, but which may also include ROM, flash RAM, or the like), an input/output controller 1218, an external audio device, such as a speaker system 1220 via an audio output interface 1222, an external device, such as a display screen 1224 via display adapter 1226, serial ports 1228 and 1230, a keyboard 1232 (interfaced with a keyboard controller 1233), multiple USB devices 1292 (interfaced with a USB controller 1291), a storage interface 1234, a floppy disk unit 1237 operative to receive a floppy disk 1238, a host bus adapter (HBA) interface card 1235A operative to connect with a Fibre Channel network 1290, a host bus adapter (HBA) interface card 1235B operative to connect to a SCSI bus 1239, and an optical disk drive 1240 operative to receive an optical disk 1242. Also included are a mouse 1246 (or other point-and-click device, coupled to bus 1212 via serial port 1228), a modem 1247 (coupled to bus 1212 via serial port 830), and a network interface 848 (coupled directly to bus 812).

Bus 1212 allows data communication between central processor 1214 and system memory 1217, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the file association application 104-d to implement the present systems and methods may be stored within the system memory 1217. The file association application 104-d may be an example of the application 104 of FIG. 1, 8, 9, or 10. Applications resident with computer system 1210 are generally stored on and accessed via a non-transitory computer readable medium, such as a hard disk drive (e.g., fixed disk 1244), an optical drive (e.g., optical drive 1240), a floppy disk unit 1237, or other storage medium. Additionally, applications can be in the form of electronic signals modulated in accordance with the application and data communication technology when accessed via network modem 1247 or interface 1248.

Storage interface 1234, as with the other storage interfaces of computer system 1210, can connect to a standard computer readable medium for storage and/or retrieval of information, such as a fixed disk drive 844. Fixed disk drive 1244 may be a part of computer system 1210 or may be separate and accessed through other interface systems. Modem 1247 may provide a direct connection to a remote server via a telephone link or to the Internet via an internet service provider (ISP). Network interface 1248 may provide a direct connection to a remote server via a direct network link to the Internet via a POP (point of presence). Network interface 1248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 12 need not be present to practice the present systems and methods. The devices and subsystems can be interconnected in different ways from that shown in FIG. 12. The operation of a computer system such as that shown in FIG. 12 is readily known in the art and is not discussed in detail in this application. Code to implement the present disclosure can be stored in a non-transitory computer-readable medium such as one or more of system memory 1217, fixed disk 1244, optical disk 1242, or floppy disk 1238. The operating system provided on computer system 1210 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of” In addition, for ease of use, the words “including” and “having,” as used in the specification and claims, are interchangeable with and have the same meaning as the word “comprising.”

In conclusion, the present exemplary system provides for a user intuitive interface that allows for the association of data and multimedia with a line item on a dynamic line item form.

The preceding description has been presented only to illustrate and describe embodiments of the principles described herein. It is not intended to be exhaustive or to limit the disclosure to any precise form disclosed. The principles described herein may be practiced otherwise than is specifically explained and illustrated without departing from their spirit or scope. For example, the principles described herein may be implemented in a wide variety of electronic marketing applications, medical applications, construction applications, military applications such as field exploration, and the like. It is intended that the scope of the present exemplary system and method be defined by the following claims.

What is claimed is:

1. A computer-implemented method to associate multimedia files with a document line item, comprising:
generating a graphical user interface configured to receive the entry of line item information;
accessing one or more multimedia recording functionalities of said computing device;
collecting a multimedia file;
associating said multimedia file with a line item entered into said graphical user interface.

2. The method of claim 1, further comprising transmitting the multimedia file to a remote computing device.

3. A computing system configured to associate multimedia files with a document line item, comprising:
a processor;
memory in electronic communication with the processor;
a file association application stored in the memory, the application comprising:
an audio recording module programmed to collect audio recordings and associate the audio recordings to a line item in a document;
a video recording module programmed to collect video recordings and associate the video recordings to a line item in a document;
an image recording module programmed to collect images and associate the images to a line item in a document;
a document recording module programmed to collect documents and associate the documents to a line item in a document; and
a display configured to graphically display the association of the audio recordings, the video recordings, the image recordings, and the documents to said line item.

4. A computer-program product for associating multimedia files with a document line item, the computer-program product comprising a non-transitory computer-readable medium having instructions thereon, the instructions comprising:
code programmed to generate a graphical user interface configured to receive the entry of line item information;
code programmed to access one or more multimedia recording functionalities of said computing device;
code programmed to collect a multimedia file; and
code programmed to associate said multimedia file with a line item entered into said graphical user interface.
